(19) United States
(12) Patent Application Publication
(10) Pub. No.: US 2004/0112666 A1
(43) Pub. Date: Jun. 17, 2004

(54) Steering mechanism for forklift trucks

(76) Inventors: Martin McVicar, Derryrellan, Emyvale (IE); Robert Moffat, The Octagon, Clontibert (IE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/471,707

(22) PCT Filed: May 11, 2001
(86) PCT No.: PCT/IE01/00062

(30) Foreign Application Priority Data
Mar. 13, 2001 (IE) S2001/0241

(51) Int. Cl. B60K 17/00

(52) U.S. Cl. 180/305

(57) ABSTRACT

A forklift truck steerable along at least two opposite directions of travel by a hydraulic circuit includes at least one hydraulic cylinder (22) coupled to at least one steerable ground-engaging wheel (18) and a driver's steering wheel (20) for controlling the supply of hydraulic fluid under pressure selectively to the full bore or piston rod side of the cylinder. The hydraulic circuit also includes a diverter valve (32) which is switched over when the truck is driven in one of the two directions to cause the truck to steer in the same direction as the steering wheel is turned in whichever of the opposite directions the truck is travelling.

### BACKGROUND OF THE INVENTION

1. Field of the Invention

This invention relates to forklift trucks, and in particular to steering mechanisms therefor.

2. Prior Art

The steering on a conventional forklift truck operates in such a way that when the driver turns the steering wheel clockwise the forklift truck steers clockwise when driving forwards, i.e. the forklift truck follows the direction of the steering wheel. However, when driving in reverse the forklift truck steers the opposite direction to which the driver turns the steering wheel. All drivers take for granted that when steering a forklift truck in reverse the unit steers opposite to the direction of the steering wheel. This is the case on almost all vehicles including cars, buses etc.

When driving a conventional 2-way reach forklift truck a similar steering effect takes place (a 2-way reach forklift truck is one which can only move sideways, left or right, relative to the forward-facing direction of the driver). Thus the driver does not face the direction of travel.

When such a forklift truck is driven to the left, relative to the forward direction of the driver who would be looking over his left shoulder at this point with his body slightly turned to the left in his seat, the unit steers just like a conventional forklift truck going forwards. Thus the forklift truck steers in the same direction as the steering wheel is turned.

However, when the forklift truck is driven to the right the unit steers in the opposite direction to which the driver turns the steering wheel. The forklift truck does not steer in the direction of the steering wheel. This is very difficult for an operator to accept or adapt to, since the operator can just as easily look left or right which at any given time is subjectively the forward direction for him yet the forklift truck steering acts inconsistently according to the direction of travel.

It is an object of the present invention to provide a solution to overcome this steering problem.

### SUMMARY OF THE INVENTION

According to the present invention there is provided a forklift truck steerable along at least two opposite directions of travel by a hydraulic circuit including at least one hydraulic cylinder coupled to at least one steerable ground-engaging wheel, the truck further including a driver's steering wheel for controlling the supply of hydraulic fluid under pressure selectively to the full bore or piston rod side of the cylinder, wherein the hydraulic circuit includes means operable to cause the truck to steer in the same direction as the steering wheel is turned whichever of the said opposite directions the truck is travelling.

Preferably the two opposite directions of travel are sideways relative to the direction faced by the driver.

The forklift truck may be a 2-way or 4-way forklift truck.

### BRIEF DESCRIPTION OF THE DRAWINGS

Embodiments of the invention will now be described, by way of example, with reference to the accompanying drawings, in which:

FIG. 1 is a plan view of a conventional two-way reach forklift truck illustrating driving to the left while turning the steering wheel clockwise;

FIG. 2 shows the operation of the hydraulic steering circuit of the conventional truck under the conditions of FIG. 1;

FIG. 3 is a plan view of the conventional two-way reach forklift truck illustrating driving to the right while turning the steering wheel clockwise;

FIG. 4 shows the operation of the hydraulic steering circuit of the conventional truck under the conditions of FIG. 3;

FIG. 5 is a plan view of a forklift truck according to the embodiment of the invention illustrating driving to the left while turning the steering wheel clockwise;

FIG. 6 shows the operation of the hydraulic steering circuit of the truck according to the embodiment under the conditions of FIG. 5;

FIG. 7 is a plan view of the truck according to the embodiment illustrating driving to the right while turning the steering wheel clockwise; and

FIG. 8 shows the operation of the hydraulic steering circuit of the truck according to the embodiment under the conditions of FIG. 7.

### DETAILED DESCRIPTION OF A PREFERRED EMBODIMENT

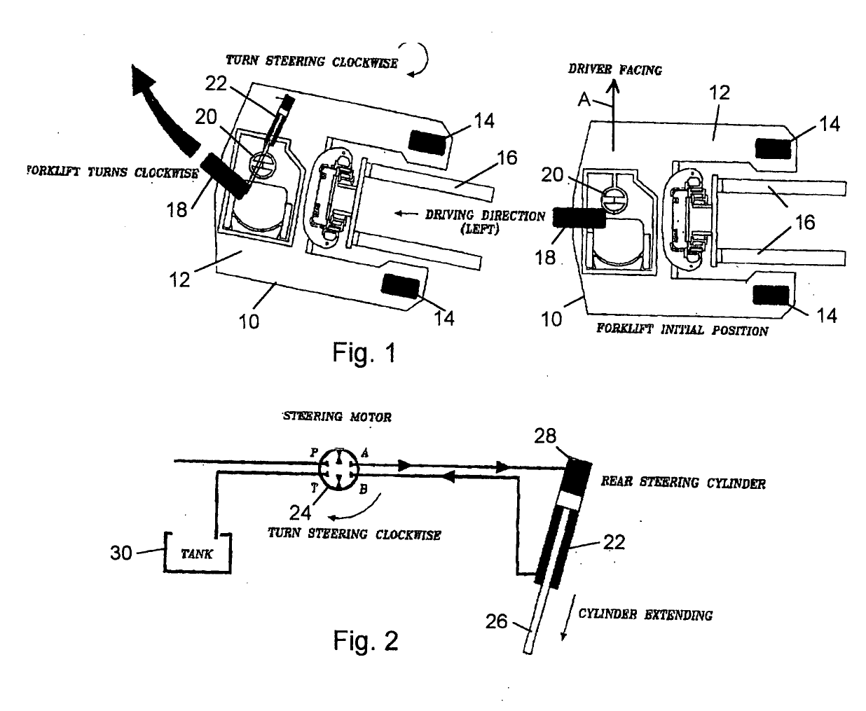

The construction and operation of a conventional 2-way reach forklift truck will first be described with reference to FIGS. 1 to 4.

FIG. 1 shows the conventional two-way reach forklift truck 10 both in an initial position (right hand side of FIG. 1) and also being driven to the left (left hand side of FIG. 1). The truck 10 includes a chassis 12 with two ground-engaging wheels 14 on the right, one on either side of the forks 16, and a single ground-engaging wheel 18 at the centre of the chassis on the left. The wheel 18 is mounted in a wheel support (not shown) which is pivotable about a vertical axis in conventional manner to allow the truck to be steered by rotating the wheel 18 clockwise or anticlockwise about the vertical axis. A conventional electric motor or engine and operator controls allow the truck 10 to be driven left or right relative to the forward-facing direction of the driver indicated by the arrow A. Except for the driver's steering wheel 20 these conventional components are not shown.

The truck 10 is steered by a hydraulic circuit (FIG. 2) including a hydraulic cylinder 22 and a so-called steering motor 24. The cylinder 22 has its piston rod 26 pivoted to the support for the wheel 18 and its barrel 28 pivoted to the chassis 12. By extending or retracting the cylinder 22 the wheel 18 can be turned clockwise or anticlockwise respectively to steer the truck.

The steering motor 24 is a conventional steering orbital unit (essentially a multi-way valve) having four ports P, T, A and B. Ports A and B are connected to the full bore and piston rod sides respectively of the hydraulic cylinder 22, port P is connected to a source of hydraulic oil under pressure (not shown), and port T to a tank 30. The unit 24 is coupled to the steering wheel 20 such that when the steering wheel 20 is turned in a clockwise direction the port P is connected to the full bore side of the cylinder 22 via port A, so that the oil under pressure causes the cylinder 22 to extend and thereby rotate the wheel 18 clockwise. Similarly, when the steering wheel 20 is turned in an anticlockwise direction the port P is connected to the piston rod (annular) side of the cylinder 22 via port B, so that the cylinder 22 retracts and rotates the wheel 18 anticlockwise. In each case, when the port P is connected to one of the ports A or B the other port B or A is connected to port T.

Thus, starting from the initial position shown at the right hand side of FIG. 1, if the truck 10 is driven to the left and the steering wheel 20 is turned clockwise, the truck will likewise steer in a clockwise direction as shown at the left hand side of FIG. 1. Similarly, if the truck 10 is driven to the left and the steering wheel 20 is turned anticlockwise, the truck will steer in an anticlockwise direction. This corresponds to the expected behaviour of conventional vehicles such as cars, buses, etc., when driven in a forward direction.

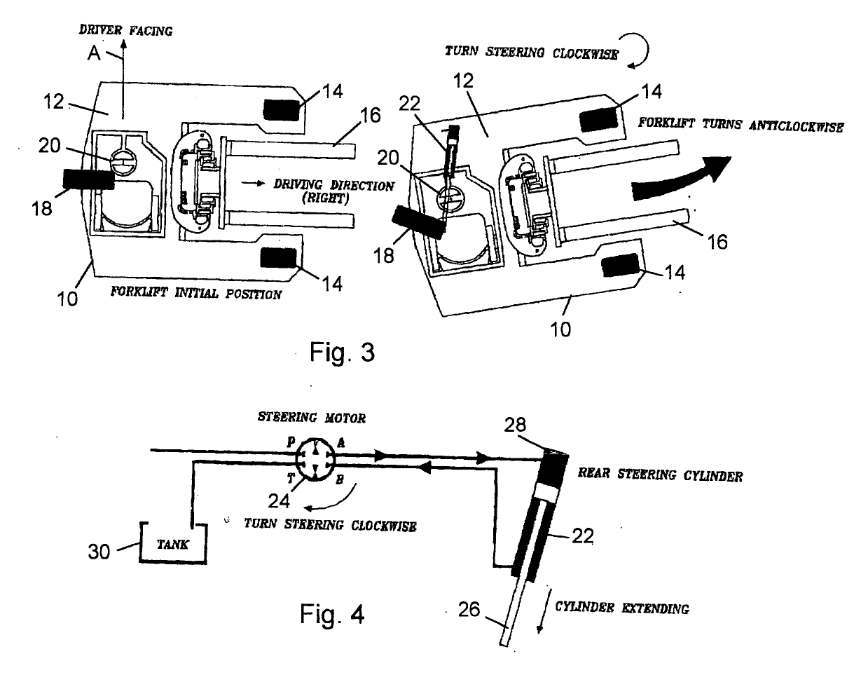

However, again starting from the initial position, now shown at the left hand side of FIG. 3, if the truck 10 is driven to the right and the steering wheel 20 is turned clockwise, the truck will steer in an anticlockwise direction as shown at the right hand side of FIG. 3. Similarly, if the truck 10 is driven to the right and the steering wheel 20 is turned anticlockwise, the truck will steer in a clockwise direction. This is exactly the opposite of the expected behaviour.

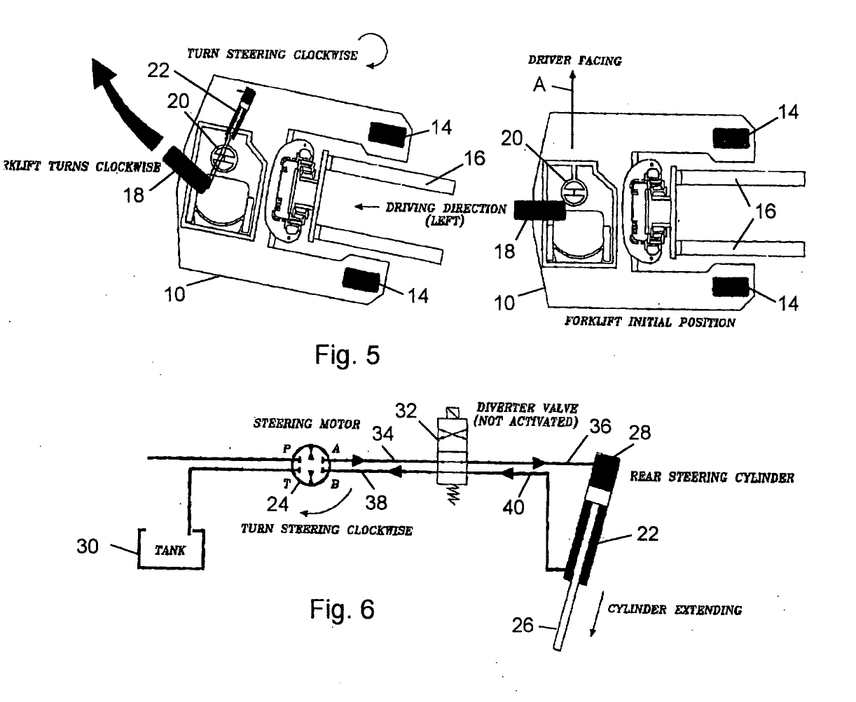

This problem is overcome by the embodiment of the invention shown in FIGS. 5 to 8.

This embodiment differs from the conventional truck described above by providing a diverter valve 32 in the hydraulic circuit between the steering motor 24 and the hydraulic cylinder 22. The diverter valve 32 has two positions, FIGS. 6 and 8. In the position of FIG. 6 the hydraulic line 34 is connected to the hydraulic line 36 and the hydraulic line 38 to the hydraulic line 40. However, in the position of FIG. 8 the hydraulic line 34 is connected to the hydraulic line 40 and the hydraulic line 38 to the hydraulic line 36.

It will be evident that when the diverter valve is in the FIG. 6 position the steering control of the truck 10 is exactly the same as described for the conventional truck. Thus, starting from the initial position shown at the right hand side of FIG. 5, if the truck 10 is driven to the left and the steering wheel 20 is turned clockwise, the truck will steer in a clockwise direction as shown at the left hand side of FIG. 5. Similarly, if the truck 10 is driven to the left and the steering wheel 20 is turned anticlockwise, the truck will steer in an anticlockwise direction.

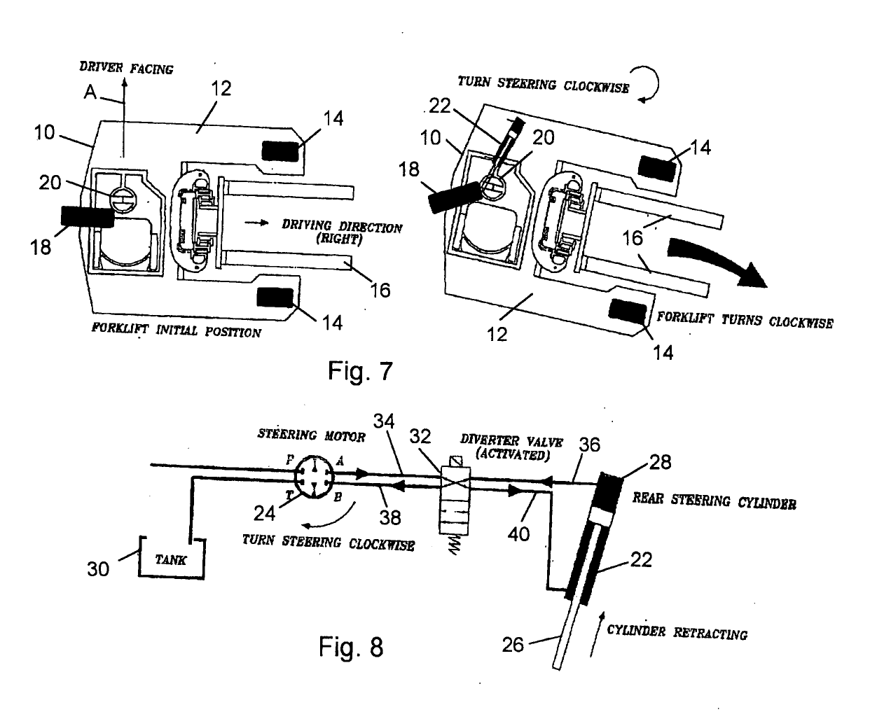

If the diverter valve 32 were to remain in this position when driving to the right, the same problem would occur as with the conventional truck. Therefore, when driving to the right, FIG. 7, the diverter valve is switched over to the FIG. 8 position.

Now, starting from the initial position shown at the left hand side of FIG. 7, if the truck 10 is driven to the right and the steering wheel 20 is turned clockwise, the truck will also steer in a clockwise direction, as shown at the right hand side of FIG. 3, because this time the oil under pressure is supplied to the piston rod side of the cylinder 22. Similarly, if the truck 10 is driven to the right and the steering wheel 20 is turned anticlockwise, the truck will steer in an anticlockwise direction. This is the required behaviour.

The switching over of the diverter valve 32 thus ensures that when the forklift truck is driving sideways, regardless of which direction, when the operator turns the steering wheel clockwise the forklift truck turns clockwise and when the operator turns the steering wheel anti-clockwise the forklift truck turns anti-clockwise. This will enable the driver to adapt much faster to operating a 2-way reach forklift truck. The diverter valve 32 can be switched over automatically from the driver's left/right drive selection switch using electric, hydraulic or pneumatic power, or it may be operated manually by the driver, or a combination of any of the above may be employed.

A similar problem arises in the case of 4-way forklift trucks, i.e. trucks which can be driven forwards and backwards as well as sideways relative to the driver's forward facing direction. Some have designed the forklift truck so that when driving to the right the unit steers as if it is going forwards, i.e. when the driver turns the steering wheel clockwise the forklift truck steers clockwise and vice versa. This means that while driving to the left, when the driver turns the steering wheel clockwise the forklift truck steers anti-clockwise. Others have developed the forklift truck so that when driving to the left the unit steers as if it is going forwards and while driving to the right the unit steers opposite to the direction of the steering wheel.

This is very difficult for an operator to accept or adapt to as the operator can as easily look left or right. It is very confusing that the steering should turn the forklift truck in the opposite direction when going in one direction versus the other direction.

Other 4-way forklift truck manufacturers have compromised the design by turning the operator at an angle between 0 and 90 degrees, so that the operator is neither facing forwards or sideways.

The use of a diverter valve as described eliminates any confusion when driving from left or right in a 4-way forklift truck. The implementation is essentially the same as for the 2-way truck. The diverter valve 32 is incorporated in the hydraulic circuit for sideways steering so that when the driver selects one of sideways directions (the one which would otherwise cause the truck to steer in the opposite direction to the direction of rotation of the steering wheel) the flow of oil under pressure from the steering motor is reversed to the opposite side of the sideways steering cylinder.

This now ensures that when a 4-way forklift truck is driving in a sideways direction, regardless of which direction, when the operator turns the steering wheel clockwise the forklift truck turns clockwise. Similarly, when the operator turns the steering wheel anti-clockwise the forklift truck turns anti-clockwise. This will enable the driver to adapt much faster to operating a specialised 4-way forklift truck.

Although described in relation to forklift trucks having one wheel 18 for sideways steering, the invention is applicable to 2- or 4-way forklift trucks having two wheels 18 for sideways steering. In such a case the two wheels 18 are rotated by respective cylinders 22 whose operation is synchronised, or the wheels can be driven by a single cylinder 22 and mechanically linked together. In either case one or more diverter valves, operating in synchronism, reverse the flow of oil under pressure from the steering motor to the opposite side of the sideways steering cylinder(s) for one direction of sideways travel.

The above invention allows the manufacturer to position the driver in whichever direction is most practical for the design of the forklift truck without being concerned about steering restrictions.

With the above invention fitted to a forklift truck the driver can steer the forklift truck by following his reflex reaction, i.e. turn the steering wheel clockwise the forklift truck turns clockwise or turn the steering wheel anti-clockwise the forklift truck turns anti-clockwise.

The invention is not limited to the embodiments described herein which may be modified or varied without departing from the scope of the invention.

1. A forklift truck steerable along at least two opposite directions of travel by a hydraulic circuit including at least one hydraulic cylinder coupled to at least one steerable ground-engaging wheel, the truck further including a driver's steering wheel for controlling the supply of hydraulic fluid under pressure selectively to the full bore or piston rod side of the cylinder, wherein the hydraulic circuit includes means operable to cause the truck to steer in the same direction as the steering wheel is turned whichever of the said opposite directions the truck is travelling.

2. A forklift truck as claimed in claim 1, wherein the hydraulic circuit includes a steering motor controlled by the driver's steering wheel and a selectively operable fluid diverter means connected between the steering motor and the cylinder for enabling hydraulic fluid under pressure to be applied to opposite sides of the cylinder when the truck is travelling in opposite directions respectively and the steering wheel in turned in the same direction.

3. A forklift truck as claimed in claim 2, wherein the hydraulic circuit includes first and second hydraulic lines connected between the steering motor and the diverter means, the steering motor supplying fluid under pressure selectively to the first line when in a first position and to the second line when in a second position, and third and fourth hydraulic lines connected between the diverter means and the full bore and piston rod sides of the cylinder respectively, wherein the diverter means is operable, when the steering motor is in the first position., to connect the first line to the third line when the truck is travelling in one of the opposite directions and to connect the first line to the fourth line when the truck is travelling in the other of the opposite directions, the diverter means further being operable, when the steering motor is in the second position, to connect the second line to the third line when the truck is travelling in the said one of the opposite directions and to connect the second line to the fourth line when the truck is travelling in the said other of the opposite directions.

4. A forklift truck as claimed in claim 1, 2 or 3, wherein the two opposite directions of travel are sideways relative to the direction faced by the driver.

5. A forklift truck as claimed in claim 4, wherein the forklift truck is a 2-way reach forklift truck.

6. A forklift truck as claimed in claim 4, wherein the forklift truck is a 4-way forklift truck.
